(19) United States
(12) Patent Application Publication
(10) Pub. No.: US 2014/0175878 A1
(43) Pub. Date: Jun. 26, 2014

(54) POWER-CONSUMPTION REDUCING SYSTEM AND METHOD

(71) Applicant: HON HAI PRECISION INDUSTRY CO., LTD., New Taipei (TW)

(72) Inventors: Po-Wei WANG, New Taipei (TW); Li-Wen CHANG, New Taipei (TW); Chih-Chung SHIH, New Taipei (TW)

(73) Assignee: HON HAI PRECISION INDUSTRY CO., LTD., New Taipei (TW)

(21) Appl. No.: 13/965,208

(22) Filed: Aug. 13, 2013

(30) Foreign Application Priority Data
Dec. 25, 2012 (TW) 101149677

(51) Int. Cl. H02J 4/00

(52) U.S. Cl. CPC H02J 4/00
USPC 307/24; 307/31

(57) ABSTRACT

A processor used in a multi-node system includes a detecting module, to obtain voltage and current information of all nodes in the multi-node system periodically. A calculating module calculates energy being consumed by each node of all the nodes according to the obtained voltage and current information. A determining module determines a node which needs to be reduced according to the energy calculation. A control module turns on a switch which is connected with the node whose energy needs to be reduced, thereby powering off the node whose energy needs to be reduced.

### BACKGROUND

1. Technical Field

The present disclosure relates to systems for reducing power consumption and methods, more particularly, to a power-consumption reduction system and method used in multi-node systems.

2. Description of Related Art

In a multi-node system, each node may have a different rate of power-consumption. Therefore, it is wasteful of power if a same level of power is supplied to each node.

Therefore, it is desirable to provide power-consumption reducing system and method used in multi-node systems, which can overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments.

FIG. 1 is a schematic view of a multi-node system in accordance with an embodiment of the present disclosure.

FIG. 2 is a schematic view of a power-consumption reduction system used in the multi-node in FIG. 1.

FIG. 3 is a flowchart of a method of reducing power-consumption in the multi-node system of FIG. 1.

### DETAILED DESCRIPTION

Embodiments of the present disclosure will be described with reference to the drawings.

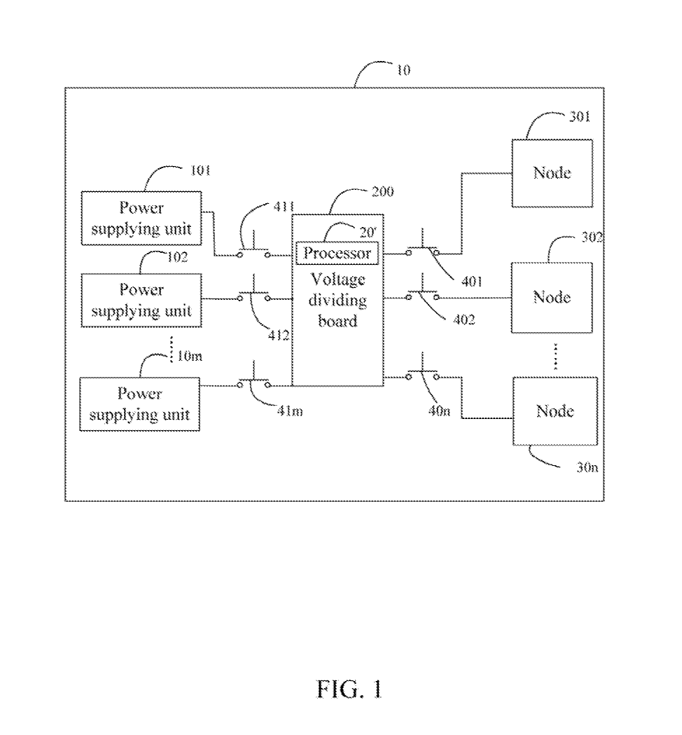

FIG. 1 is a schematic view of a multi-node system in accordance with an embodiment of the present disclosure. The multi-node system 10 includes several power supplying units 101, 102, . . . , 10m, a voltage dividing board 200, and several nodes 301, 302, . . . , 30n. Each of the nodes 301, 302, . . . , 30n can be a server or a mainboard.

The power supplying units 101, 102, . . . , 10m supply electrical power for the multi-node system 10. The voltage dividing board 200 converts the power into working voltages, and sends the working voltages to the nodes 301, 302, . . . , 30n. The voltage dividing board 200 is a programmable chip, for example, NXP LPC1768.

The multi-node system 10 further includes several switches 411, 421, . . . , 41m, and 401, 402, . . . , 40n. A quantity of the switches 411, 421, . . . , 41m, and 401, 402, . . . , 40n is the same as a quantity of all the nodes 301, 302, . . . 30n and all the power supplying units 101, 102, . . . , 10m. One end of each of the switches 411, 421, . . . , 41m, and 401, 402, . . . , 40n is connected with the voltage dividing board 200. The other end of each of the switches 401, 402, . . . , 40n is connected with one node of all the nodes 301, 302, . . . , 30n, and the other end of each of the switches 411, 421, . . . , 41m is connected with one of the power supplying units 101, 102, . . . , 10m.

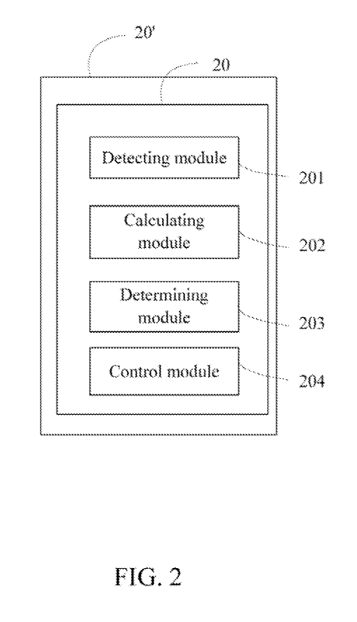

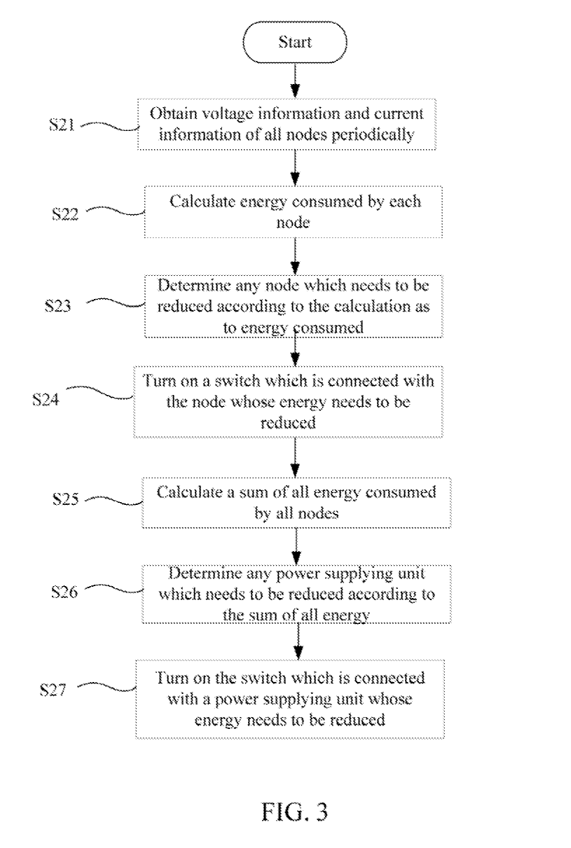

FIG. 2 is a schematic view of a power-consumption reduction system used in the multi-node system in FIG. 1. The power-consumption reducing system 20 runs on a processor 20′ of the voltage dividing board 200. The power-consumption reducing system 20 includes a detecting module 201, a calculating module 202, a determining module 203, and a control module 204, all of which are software instructions. Functions of the modules will be described with reference to FIG. 3.

FIG. 3 is a flowchart of a power-consumption reducing method of protecting the multi-node system of FIG. 1. The power-consumption reducing method is running on the voltage dividing board 200.

In step S21, the detecting module 201 obtains voltage and current information of all nodes 301, 302, . . . , 30n periodically.

In step S22, the calculating module 202 calculates energy consumed by each node of the nodes 301, 302, . . . , 30n according to the obtained voltage and current information.

In step S23, the determining module 203 determines any node which needs to be reduced according to the calculation as to energy consumed. For example, the determining module 203 determines the node which needs to be reduced by determining the node whose energy consumed most. In detail, the determining module 203 sorts all the nodes 301, 302, . . . , 30n according to energy calculations in sequence, thereby determining which node consumes the highest energy, and then the node which consumes the highest quantity of energy is determined as being the node whose energy consumption needs to be reduced.

In step S24, the control module 204 turns on the switch which is connected with the node whose energy needs to be reduced, thereby powering off the node whose energy needs to be reduced.

In step S25, the calculating module 202 calculates a sum of all energy consumed by all nodes 301, 302, . . . , 30n.

In step S26, the determining module 203 determines any power supplying unit which needs to be reduced according to the sum of all energy of all nodes 301, 302, . . . , 30n. For example, the determining module 203 determines the smallest number of all the power supplying units which can provide the sum of all energy being consumed by all nodes 301, 302, . . . , 30n, and power supplying units which are not included in the smallest number are determined to be the power supplying units which can be reduced.

In step S27, the control module 204 turns on the switch which is connected with a power supplying unit whose energy needs to be reduced.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A processor used in a multi-node system, comprising:
a detecting module, to obtain voltage and current information of all nodes in the multi-node system periodically;
a calculating module, to calculate energy consumed by each node of the nodes according to the obtained voltage and current information;
a determining module, to determine any node which needs to be reduced according to the calculation as to energy consumed; and
a control module, to turn on a switch which is connected with the node whose energy needs to be reduced, thereby powering off the node whose energy needs to be reduced.

2. The processor of claim 1, wherein the determining module determines the node which needs to be reduced by determining the node whose energy consumed most, in detail, the determining module sorts all the nodes according to energy calculations in sequence, thereby determining which node consumes the highest energy, and then the node which consumes the highest quantity of energy is determined as being the node whose energy consumption needs to be reduced.

3. The processor of claim 1, wherein the calculating module further calculates a sum of all energy consumed by all nodes, the determining module further determines any power supplying unit which needs to be reduced according to the sum of all energy of all nodes, and the control module further turns on the switch which is connected with the power supplying unit whose energy needs to be reduced.

4. The processor of claim 3, wherein the determining module determines the smallest number of all the power supplying units which can provide the sum of all energy being consumed by all nodes, and power supplying units which are not included in the smallest number are determined to be the power supplying units which can be reduced.

5. The processor of claim 1, wherein each one of the node is a server.

6. The processor of claim 1, wherein each one of the node is a mainboard.

7. The processor of claim 1, wherein the power-consumption reducing system runs on a voltage dividing board which is a programmable chip.

8. A power-consumption reducing method, comprising:
obtaining voltage and current information of all nodes in a multi-node system periodically;
calculating energy consumed by each node of the nodes according to the obtained voltage and current information;
determining any node which needs to be reduced according to the calculation as to energy consumed; and
turning on a switch which is connected with the node whose energy needs to be reduced, thereby powering off the node whose energy needs to be reduced.

9. The power-consumption reducing method of claim 8, wherein the method of determining any node which needs to be reduced according to the calculation as to energy consumed further comprises determining the node whose energy consumed most, in detail, sorting all the nodes according to energy calculations in sequence, thereby determining which node consumes the highest energy, and then the node which consumes the highest quantity of energy is determined as being the node whose energy consumption needs to be reduced.

10. The power-consumption reducing method of claim 8, wherein the method further comprises calculating a sum of all energy consumed by all nodes, determining any power supplying unit which needs to be reduced according to the sum of all energy of all nodes, and turning on the switch which is connected with the power supplying unit whose energy needs to be reduced.

11. The power-consumption reducing method of claim 10, wherein the method further comprises determining the smallest number of all the power supplying units which can provide the sum of all energy being consumed by all nodes, and power supplying units which are not included in the smallest number are determined to be the power supplying units which can be reduced.

12. The power-consumption reducing method of claim 8, wherein the power-consumption reducing method is running on a voltage dividing board which is a programmable chip.
